(19) United States
(12) Patent Application Publication
(10) Pub. No.: US 2011/0220447 A1
(43) Pub. Date: Sep. 15, 2011

(54) CURRENT COLLECTOR SYSTEM FOR A VEHICLE, IN PARTICULAR FOR RTG CONTAINER STACKER CRANES

(75) Inventors: Arno Schroder, Castrop-Rauxel (DE); Michael Heitmann, Unna (DE); Uwe Mehrwald, Dortmund (DE); Alfred Dufke, Werne (DE); Michael Raabe, Werne (DE)

(73) Assignee: Paul Vahle GmbH & Co. KG, Kamen (DE)

(21) Appl. No.: 13/129,619

(22) PCT Filed: Nov. 17, 2009
(86) PCT No.: PCT/EP2009/008179

§ 371 Date: May 17, 2011

(30) Foreign Application Priority Data
Nov. 17, 2008 (DE) 10 2008 057 765.0

(51) Int. Cl. B60L 5/04

(52) U.S. Cl. 191/50

(57) ABSTRACT

The invention relates to a current collector system for fastening to a vehicle, I particular a container stacker crane, wherein the vehicle can be moved along in a line (T), and at least one busbar (S) is arranged on the line (T), wherein the current collector system has a collector trolley (W) having at least one busbar (AB), and the at least one current collector (AB) can be brought in contact with a busbar (S), wherein the collector trolley (W) of the current collector system is mounted to be freely displaceable vertically, in particular by means of at least one guide (F).

This application is a 35 U.S.C. 371 National Stage Application of International Application Serial No. PCT/EP2009/008179, filed Nov. 17, 2009, claiming priority from German Application No. 10 2008 057 765.0, filed Nov. 17, 2008, the entire contents of which are incorporated herein in their entirety.

The present invention relates to a current and/or data transmission system using a collector trolley, a line of travel and a vehicle, the vehicle being, in particular, a container stacking crane.

About 99% of all container stacking cranes are diesel driven. Due to the constant rise in the price of diesel fuel and for noise-related and environmental reasons, attempts are being made to electrify container stacking cranes. There are a variety of container stacking cranes in use. In this way, there are narrow pneumatic-tyred straddle carriers which are used in Europe and which, due to their small width, are only able to stack containers in one row. It tends to be uneconomical for a conductor bar to be used with such straddle carriers. There are also the considerably wider rail-mounted gantry cranes which run on crane rails and which today are already being operated by means of conductor bars. As well as these, there are also rubber tyred gantry cranes which are already being widely produced and which are able to fit over more than one row of stacked containers and which travel along the rows of stacked container mainly in aisles. These cranes have pneumatic tyres because they often have to switch between the aisles which are formed by the stacks of containers. Test systems have already been installed in which the rubber tyred gantry cranes are supplied with electrical energy by conductor bars arranged in parallel. The conductor bars are arranged in this case on lines of travel along which the current collector trolleys travel, which current collector trolleys make contact with the conductor bars by their current collectors and sliding carbon pads. The current collector trolleys can be connected to the crane by electrical cables on which plug-in connectors are arranged, thus enabling the crane to obtain its electrical energy from the conductor bars. The rubber-tyred gantry cranes, known as RTG cranes for short, have an electric drive which has a diesel generator. To switch aisles, the RTG cranes change over to this “diesel drive”. Once the cranes have entered the aisle, the driver tells the assisting personnel that the cable of the current collector trolley needs to be plugged into a socket on the RTG crane. Also, the current collector trolley is hooked onto the RTG crane with chain, which means that, as the RTG crane travels along, the current collector trolley will be pulled by the chains and not by the electrical cable.

A disadvantage of the system described above is that assistants have to connect the container stacking crane (RTG crane) to the current collector trolley manually by means of the power cable, having not only to plug the electrical cable into the RTG crane for this purpose but also having to hook the chains onto it. Another disadvantage is the poor efficiency, and hence the loss of energy, in that the driving current required is first generated by means of a diesel generator and the electric drives are then supplied with it.

Known from FR 2699748 is a gantry crane in which a current collector system is arranged to be, vertically displaceable on an upright which can be displaced with the gantry crane. The vertical displacement is effected by means of a drive. The current collecting contacts are fastened rigidly to the upright, thus making it impossible for any horizontal offset from the conductor bars to be corrected.

CN 200946068 discloses a current collector system for a transporter trolley. The current collector trolley is guided by rails which, together with the conductor bars, are fastened to posts situated next to the line of travel on the surface for travel. The current collector trolley is connected, by an entraining chain, to the free end of an arm which projects sideways from the transporter trolley. The arm itself is rigid and does not have a drive. The horizontal and vertical offset between the arm and the current collector trolley is compensated for solely by the entraining chain. The only way in which the current collector trolley and the transporter trolley can be separated from one another is by releasing the chain and the electrical connecting cables manually. There is no provision for automatic coupling in this current collector system.

It is an object of the present invention to simplify, in particular to automate, the making of an electrical connection between a vehicle, in particular a container stacking crane, and the line of travel.

This object is achieved by a current collector system which has the features of claim 1. What is also claimed is a line of travel having the features of claim 16 and having the features of the claims which are referred back to claim 14, and a current and/or data transmission system.

The advantageous embodiments of the current collector system, the vehicle, the line of travel and the transmission system can be seen from the features of the dependent claims which are referred in the respective cases.

The current collector system according to the invention is suitable in general not only for container stacking cranes but also for any desired vehicles which have to travel along corresponding lines of travel and which have to be supplied with electrical energy and/or data.

The basic idea behind the invention is that automatic making of contact by the vehicle with the at least one conductor bar which is laid along the line of travel is possible by means of the current collector system. The difficulty in this case is compensating for the enormous tolerances by an automatic process. These tolerances arise from the vehicle, in particular the crane, being in a very inexact spaced position from the conductor bar system in the horizontal and vertical positions. To deal with this, the collector trolley is lined up relative to the conductor bar, and is inserted thereinto by its current collectors, by means of a positioning and inserting arrangement. For this purpose, the vehicle advantageously has an arm or some other adjusting means by means of which the collector trolley can be adjusted in the horizontal direction. In the simplest case, the line of travel has a plate for physical contact up against which the end of the arm, the adjusting means or the collector trolley can be moved by means of a drive. The end of the arm may, for this purpose; be provided with at least one pressure-applying roller or travel roller. For the current collector trolley to be inserted into the carrier rails arranged along the line of travel, the collector trolley of the vehicle has to be moved to a position in front of the positioning and inserting arrangement, after which the collector trolley is then moved in the direction of the plate for physical contact until physical contact is made with the plate for physical contact. As soon as physical contact is made with the plate for physical contact, which can be determined in particular by means of sensors or from the drive current drawn by the drive which adjusts the collector trolley in the horizontal direction, the collector trolley is lined up horizontally. The collector trolley can then be inserted into the inserting arrangement by moving the vehicle. The purpose of the inserting arrangement is to position, in particular raise, the collector trolley vertically, thus enabling it to be introduced into the conductor bar(s) by its current collectors. In a preferred embodiment, the inserting arrangement has for this purpose travel rails which—where the collector trolley has to be raised—extend upwards in the direction of travel of the vehicle. The collector trolley has travel rollers which are brought to bear against the running surface of the travel rails, which are arranged at an inclination, as a result of which the collector trolley is raised as the vehicle continues to move. Either the entire arm and the collector trolley situated thereon or only the collector trolley may be raised when this happens. In the simplest case it is only the collector trolley which is raised. The collector trolley is advantageously guided by vertically arranged rods in this case. The rods may be fastened either to the arm or to the collector trolley and are each mounted to be displaceable vertically in whichever is the other part in the given case—the arm or the collector trolley. In an alternative embodiment, rather than four vertical bars, what is arranged is only one vertical tube which enables the collector trolley to perform a compensating rotation in the horizontal direction if the arm or the other adjusting means does not engage exactly at right angles to the direction of travel.

The positioning and inserting systems are each arranged at both ends of an aisle.

To ensure that the insertion of the current collectors in the conductor bars takes place by the movement of the vehicle, a receiving guiding funnel, such as is sufficiently well known from the prior art and from conductor bars such as are generally usual, may be provided at the conductor bar.

The arm on which the collector trolley is advantageously arranged may advantageously take the form of a telescopic arm. It is, however, also possible for a rigid longitudinal profile to be provided which is adjusted by means of a drive, in particular a rack and pinion drive.

The invention gives greater economy due to the lower fuel costs and a reduction in the maintenance and repair costs. A reduction in the noise level and in emissions of CO₂ and other harmful exhaust gases is achieved by the electrification of the vehicle.

By the use of conductor bars with the aisles, it is possible for the container stacking cranes to be supplied with electrical energy within the aisles. Hence a diesel drive is still required only outside the aisles. The collection of current takes place in each case via a collector trolley, in particular a current collector trolley, which travels with the crane and is mounted on it. When there is a switch between aisles, the collector trolley travels out of the line of travel and is thus automatically uncoupled. The crane can be moved into the new aisle with the help of the diesel drive.

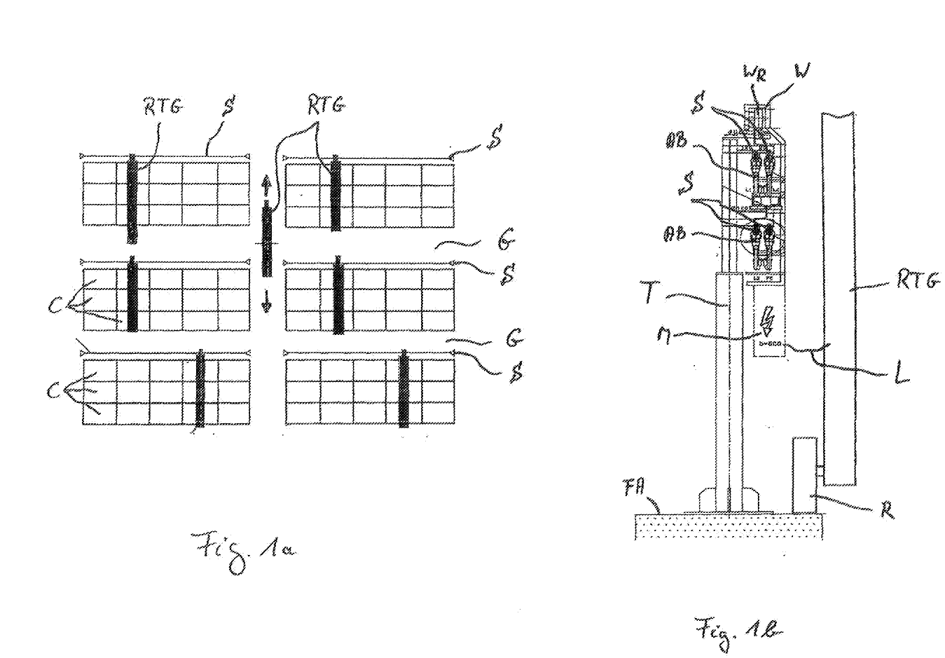

Because the space available in container ports and the requirements at them differ, it is also possible for two different arrangements of conductor bars to be used even in combination. In this way, it is possible for conductor bars to be arranged on side of all the aisles in the way shown in FIG. 1a. The aisles G are formed by the stacks C of containers. The cranes RTG travel in this case either parallel to the conductor bars or lines of travel S, in which case they are driven by their electric drives. As soon as the cranes RTG leave the aisles G, they can home in on a different aisle G by means of their diesel drive.

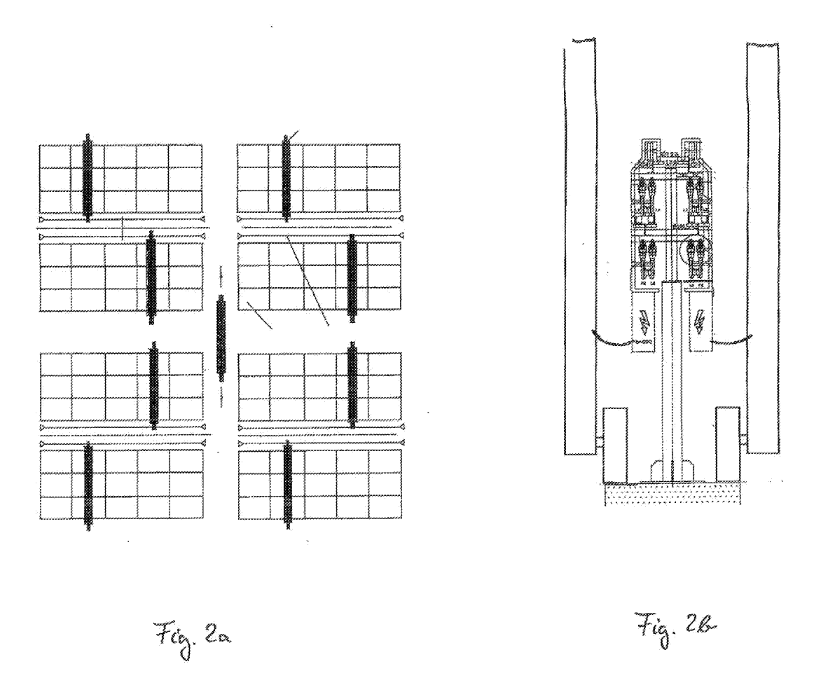

FIG. 1b is a view in cross-section through a line of travel T known from the prior art on one side of which four conductor bars S are fastened. A collector trolley W is able to move along the line of travel T and is mounted on rollers AB_{R} which roll on a travel track on the line of travel T. The collector trolley W has a plurality of current collectors AB which rest on the conductor bars S by means of sliding carbon pads. Arranged above or below the current collector trolley W is an electrical module M which is moved along the line of travel T together with the current collector trolley W. In the test systems known from the prior art, an electrical lead L connects the module M to the crane RTG, which latter can be moved along the line of travel T, on a surface for travel F, by means of rubber tyres R. The chains or cables for entraining the trolley W are not shown. FIGS. 1a and 1b show conductor bars arranged on only one side of the line of travel T. It is, however, also possible for conductor bars S to be arranged along the line of travel T on both of its sides, thus causing the line of travel T to be arranged between two RTG cranes in the way shown in FIGS. 2a and 2b.

In contrast to the known test system, in the system according to the invention each crane may have one collector trolley, which is fastened to the crane itself, associated with it. This gives an enormous benefit in terms of costs because in this way the number of collector trolleys is the same as the number of cranes. In contrast to this, what were used in the old systems were a plurality of collector trolleys for each line of travel in order to provide a facility for plugging-in for each of the crane's “workplaces”.

In the simplest case, the current collector system according to the invention comprises an arm, which may in particular be a telescopic arm, which can be Mounted on the vehicle by one end and whose other end carries the collector trolley. The collector trolley is mounted to be freely displaceable in the vertical direction on the arm in this case, thus enabling it to be raised as appropriate for insertion into the conductor bars.

By the advantageous use of diabolo rollers, which are characterised in that they have a concave, inwardly curved, almost semi-circular or conical running surface, the usual four guiding rails can be replaced by two rods or tubes of circular cross-section. For the collector trolley to be safely and reliably guided and centralised, all that is then still needed on the collector trolley is only three travel rollers in the form of diabolo rollers. A guiding system comprising diabolo rollers and circular bars or tubes may also advantageously be provided for the vertical guidance and mounting of the collector trolley on the head of the telescopic arm. All in all, the system can be produced and assembled in a substantially simplified, more compact, and considerably lighter and less expensive form by the use of the travel rollers described above, with the guidance of the collector trolley being optimised at the same time. Also, for the same weight, a guide tube can be produced more advantageously and with a greater moment of resistance against bowing than conventional supporting rails in the form of U-profiles.

The invention will be explained in detail below by reference to drawings. In the drawings:

FIGS. 1a and 1b show conductor bars arranged on one side of a line of travel.

FIGS. 2a and 2b show an arrangement of conductor bars on two sides of a line of travel.

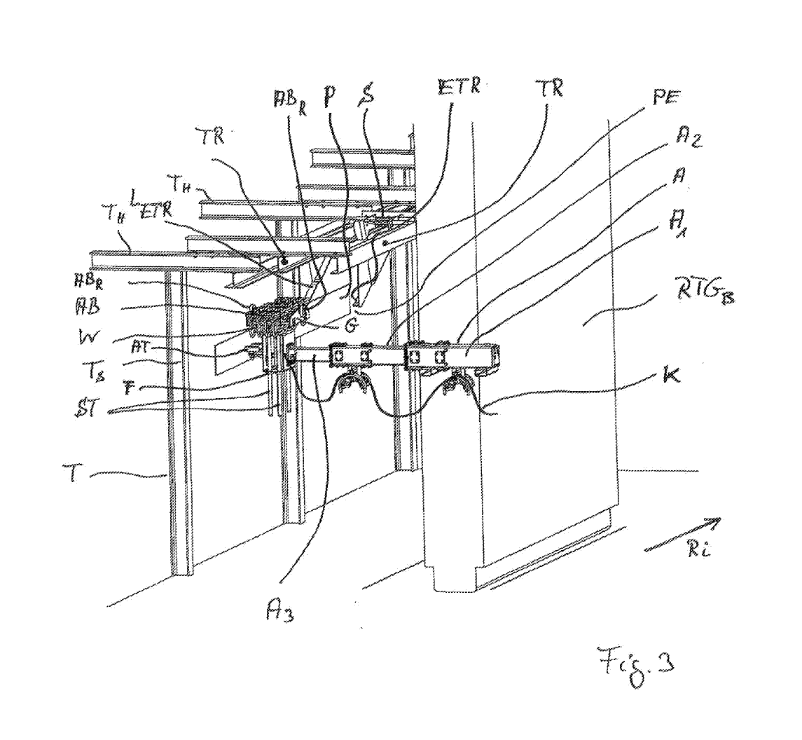

FIG. 3 shows an embodiment of vehicle and line of travel according to the invention—having an arm end which is moved against a plate.

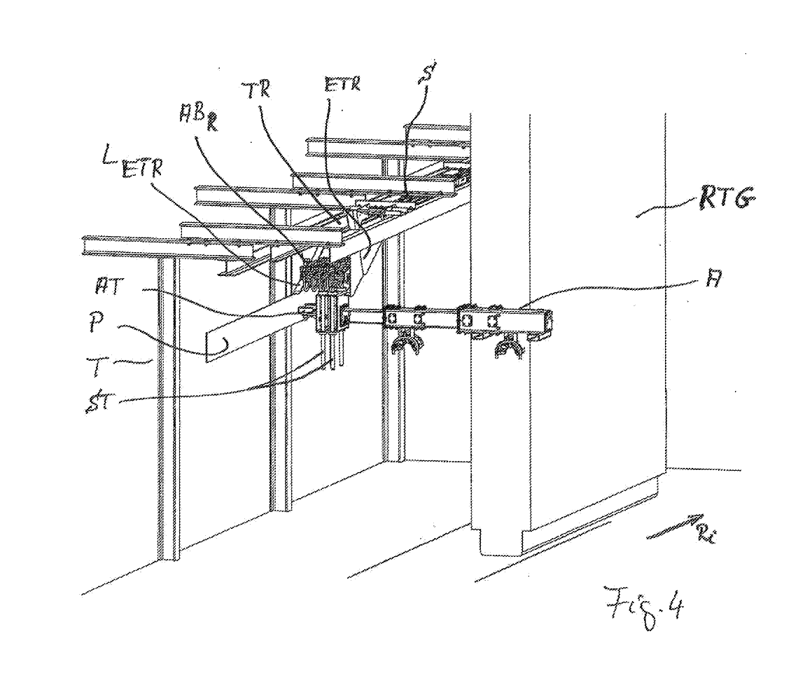

FIG. 4 shows a collector trolley being raised by the positioning and inserting arrangement.

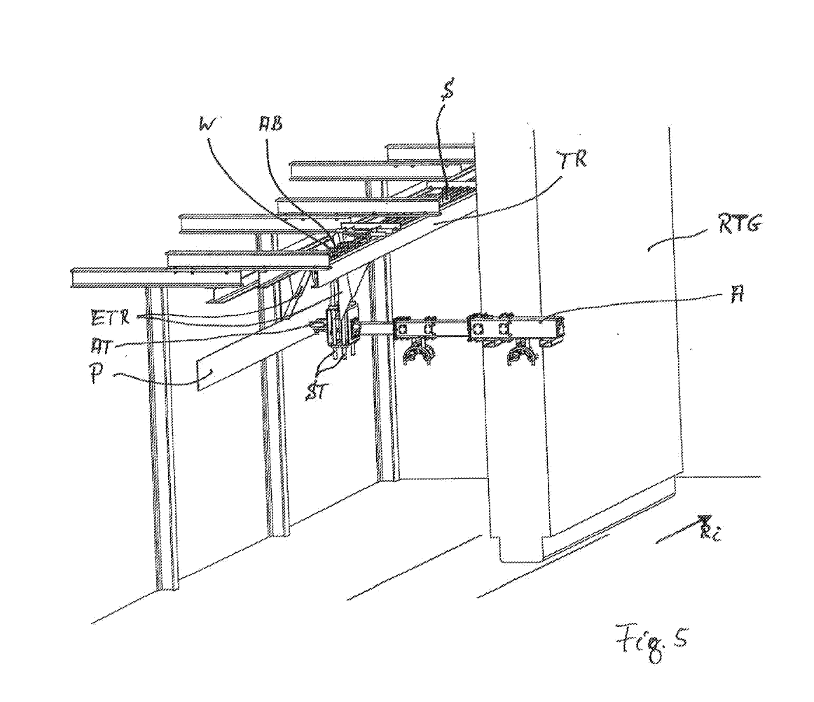

FIG. 5 shows a collector trolley which has been fully raised, and which can be inserted in the conductor bar by its current collectors as a result of further movement of the vehicle.

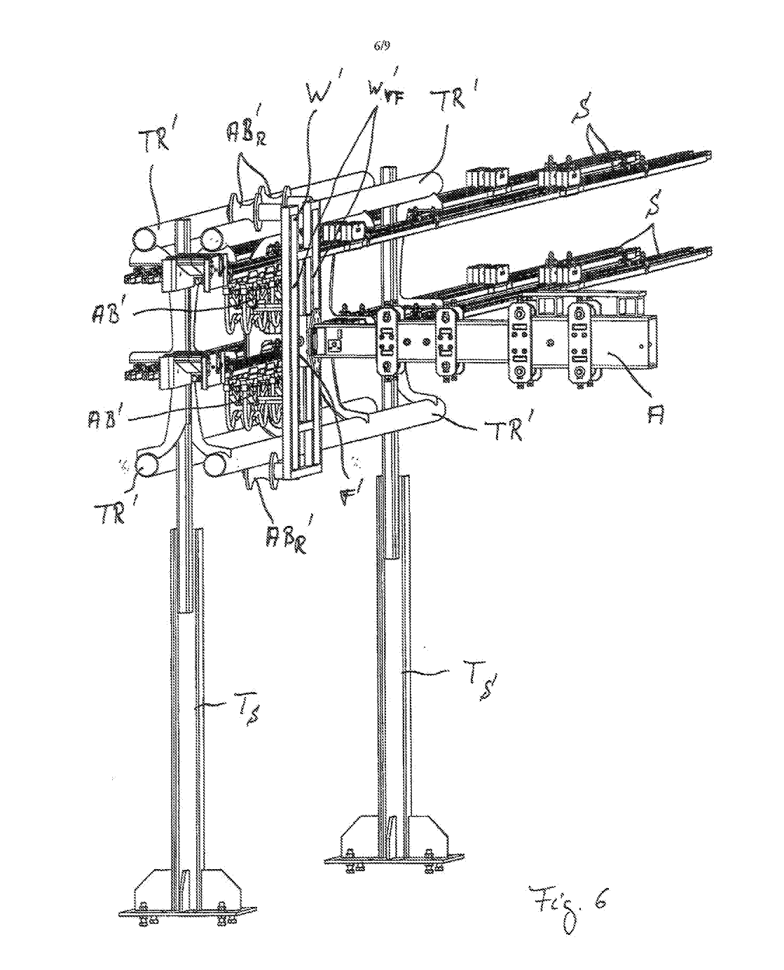

FIG. 6 is a perspective view of a second possible embodiment of collector trolley and line of travel in which there are circular bars as supporting rails.

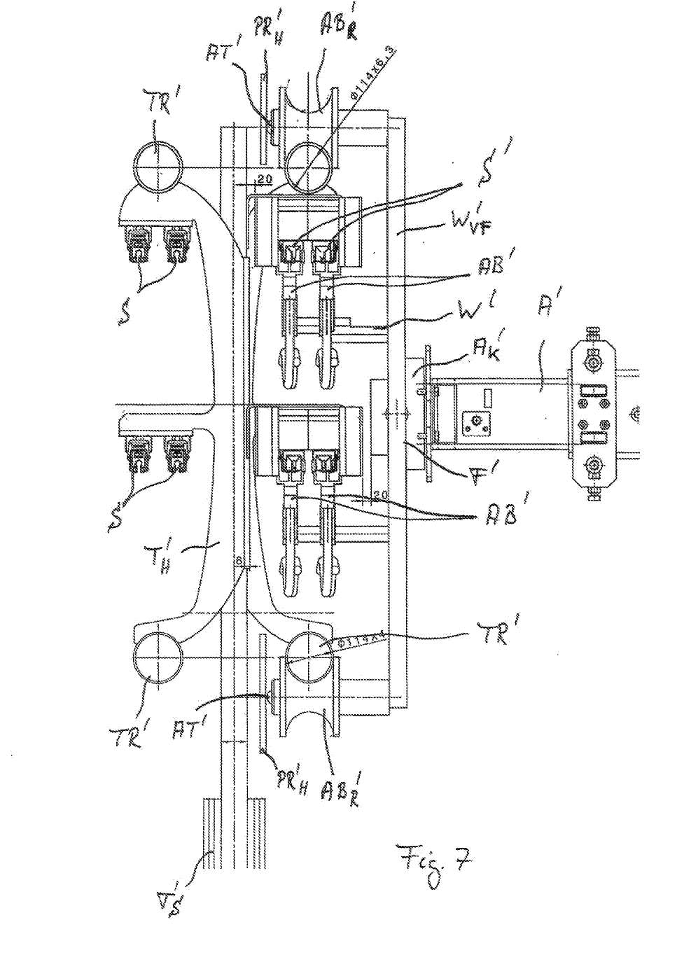

FIG. 7 is an end-on view, partly in section, of the line of travel and collector trolleys shown in FIG. 6.

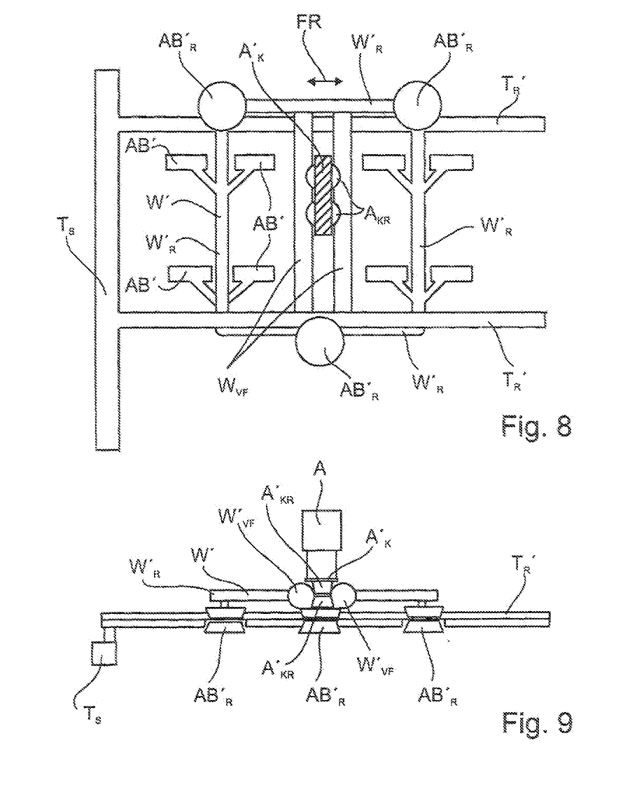

FIG. 8 is a schematic view of the embodiment shown in FIGS. 6 and 7.

FIG. 9 is a plan view of the arrangement shown in FIG. 8.

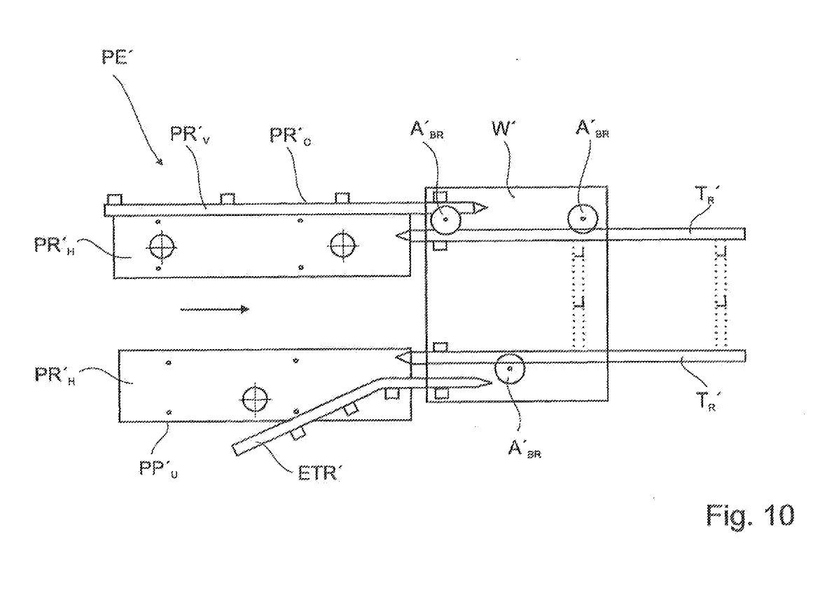

FIG. 10 is a schematic view of an inserting arrangement for the embodiment shown in FIGS. 6 to 9.

FIG. 3 shows a line of travel T according to the invention comprising vertical pillars T_{S} and horizontal beams T_{H}. Arranged on the horizontal beams T_{H} are conductor bars S and supporting rails TR. FIG. 3 shows the point along the lines of travel at which the positioning and inserting arrangement PE is arranged, i.e. the point at which the vehicle RTG, which is in particular a crane, has to be positioned so that the collector trolley W which is arranged on the vehicle RTG can be inserted into the line of travel T, or rather the conductor bar S. All that is shown, schematically, of the crane RTG is a leg RTG_{B} by means of a vertical cuboid, on which at least one tyre is generally mounted. Fastened to the leg RTG_{B} is a telescopic arm A comprising individual arm portions A₁, A₂ and A₃. Arranged at the leading end of the last portion A₃ is a part AT for making physical contact in the form of one or two pressure-applying rollers. By the extension of the telescopic arms A, the rollers AT will finally butt against the plate P, as a result of which the collector trolley W, which is also arranged on the portion A₃, will likewise be lined up horizontally for insertion into the supporting rails ETR of the inserting arrangement PE. Fastened to the collector trolley W are vertically arranged rods ST which are mounted to be vertically displaceable on the arm A in guides F. As soon as the crane RTG is moved in the direction of travel Rᵢ, the travel rollers AB_{R} are placed against the running surfaces L_{ETR} of the supporting rails ETR, which are arranged at an inclination, as a result of which the collector trolley W, together with the rods ST, is raised as the travel in the direction Rᵢ continues. The supporting rails ETR of the inserting arrangement PE, which are arranged at an inclination to form a ramp, end in an adjoining position in the region of the supporting rails TR, which are so arranged that the collector trolley follows the line of travel T and the conductor bar S and it is ensured that the current collectors AB are always in contact with the conductor bars S. The collector trolley W has a housing G on which the rods, the resiliently mounted current collectors AB and the travel rollers AB_{R} are arranged. Via a flexible cable K which is suspended from the individual portions Aᵢ of the telescopic arm A, the current collectors AB are connected to the electronics of the crane.

FIG. 4 shows a position in which the crane RTG has moved in the direction Rᵢ and the travel rollers AB_{R} of the collector trolley W have already come to rest on the running surface L_{ETR}.

FIG. 5 shows a position in which the collector trolley W has been raised to the height of the supporting rails TR, as a result of which the rods ST have been shifted upwards with it but are still in their guides F.

As a rule, the crane RTG or vehicle is not track-mounted, and it may thus happen, as it moves in the direction of travel Rᵢ, that the distance between the vehicle and the line of travel T changes. Changes in distance in the vertical direction are also constantly occurring, which changes may for example be caused by differences in the air pressure in the tyres and general tolerances in the heightwise direction. To enable these changes in distance to be continuously compensated for, it has to be ensured that the collector trolley is able to move relative to the vehicle in the horizontal direction. The telescopic arm A must therefore be so designed that its length is able to vary as a result of the forces acting between the line of travel and the vehicle. The vertical rods (ST) or a vertical tube make the vertical compensation possible.

FIGS. 6 to 9 show a further possible embodiment in which the collector trolley W′ is mounted on the head A′_{K} of the telescopic arm A′ to be displaceable in the vertical direction. For this purpose, there are rotatably mounted on the head A′_{K} of the telescopic arm A′ rollers A′_{KR} which run in the vertically arranged guides W′_{VF} of the collector trolley and stop the collector trolley from tilting. Arranged on the collector trolley W′ are the current collectors AB′, which engage in the conductor bars S′ to make contact. The pillars T′_{S} of the line of travel carry the supporting rails T_{R}′ which are formed by rods of circular cross-section. Arranged on the collector trolley W as travel rollers are diabolo rollers AB′_{R} which serve to centralise the collector trolley W′ horizontally and vertically. The diabolo rollers AB′_{R} have a running surface which is concave or which is approximately circular in cross-section and which rests against the supporting rails T_{R}′ which are circular in cross-section. Basically, three rollers AB′_{R} are enough for the collector trolley W′ to be safely and reliably guided. It is of course also possible for more than three rollers to be provided, e.g. two upper ones and two lower ones.

FIG. 7 is an end-on view, partly in section, of the line of travel with its pillars T′_{S} and the supporting rails T_{R} and conductor bars S′ which are fastened thereto by means of brackets T′_{H}. Arranged on a pillar T′_{S} of the line of travel are the brackets T′_{H} for the guiding rails T′_{R} in opposite positions, which means that a compact line of travel which takes up only a small amount of space can be produced because there are now only two guiding and supporting rails T′_{R} which are arranged one above the other. The brackets T′_{H} for the supporting rails T′_{R} in opposite positions are bolted or riveted together or are welded together, thus enabling high strength to be obtained for the line of travel as a whole.

FIG. 8 is a schematic view of the embodiment shown in FIGS. 6 and 7. The collector trolley W′ is formed by a frame structure W′_{R} to which the travel rollers AB′_{R} and the current collectors AB′ are fastened. Also fastened to or incorporated in the supporting frame W′_{R} are the vertical guide rods W′_{VF} which are used to guide the travel rollers A′_{KR} arranged on the head A′_{K} of the telescopic arm A′. As an option, springs (not shown) may be provided which position the collector trolley W′ in a vertical position relative to the head A′_{K} of the telescopic arm A′ if the collector trolley W′ is not guided by the supporting rails T_{R}′. FIG. 9 is a plan view of the arrangement shown in FIG. 8.

FIG. 10 shows a possible embodiment of the inserting arrangement for the embodiment shown in FIGS. 6 to 9. The inserting arrangement has an upper deflecting arrangement PR′_{O} and a lower deflecting arrangement PR′_{U}. The upper deflecting arrangement PR′_{O} has a horizontal deflecting plate PR′_{H} and a vertical deflecting plate PR′_{V}, which co-operate with the upper travel rollers AB′_{R} of the collector trolley W′ to provide horizontal and vertical positioning. The lower deflecting arrangement PR′_{U} is used to line up the lower travel roller AB′_{R} of the collector trolley W′ horizontally. The insertion arrangement has at least one line of travel T′_{RR} which is arranged at an inclination, against which the lower travel roller AB′_{R} of the collector trolley W′ comes to bear at it moves towards the right. In this way, the collector trolley W′ is raised sufficiently far for the upper travel rollers AB′_{R} of the collector trolley W′ to be situated above the upper supporting rail T′_{R}. Once the collector trolley W′ has been completely introduced, its travel rollers AB′_{R} fit round the supporting rails T′_{R} from above and below, as a result of which the collector trolley W′ can no longer leave the line of travel. Relative vertical tolerances and unevennesses in the surface for travel are compensated for by the vertical guidance of the collector trolley W′ on the head A′_{K} of the telescopic arm A′.

It goes without saying that the first embodiment, which is shown and defined in FIGS. 3 to 5, may also be fitted with the diabolo rollers acting as travel rollers and with supporting rails of circular cross-section, of the kind which are shown and defined in FIGS. 6 to 10.

1. A current collector system for fastening to a vehicle, the vehicle being able to be moved along a line of travel and at, least one conductor bar being arranged on the line of travel, the current collector system including: having a collector trolley having at least one current collector wherein the at least one current collector is configured to be able to be brought into contact with a conductor bar wherein the collector trolley of the current collector system is mounted to be freely displaceable vertically, by means of at least one guide, the guide being arranged on a free end of a telescopic arm or on the collector trolley itself, wherein the arm is configured to be fastened to the vehicle, and wherein the collector trolley is able to be adjusted in a horizontal direction by means of a drive.

2.-3. (canceled)

4. The current collector system according to claim 1, wherein the telescopic arm can be extended and retracted by means of a drive.

5. The current collector system according to claim 1, wherein the collector trolley, as it moves, is held in position relative to the line of travel by means of at least one guide, which is arranged on the line of travel.

6. The current collector system according to claim 1, wherein a bearing for the collector trolley is formed by at least one vertical rod which is fastened either to the collector trolley and is displaceably mounted on the vehicle on the arm thereof, or wherein at least one vertical rod is fastened to the arm of the vehicle, on which the collector trolley is displaceably mounted.

7. The current collector system according to claim 1, wherein the collector trolley has at least one travel roller to roll on at least one supporting rail and on an inserting supporting rail of a positioning and inserting arrangement belonging to the line of travel.

8. The current collector system according to claim 1, wherein the collector trolley has a housing or frame on which the at least one current collector is resiliently mounted, at least one rod being fastened to, or being mounted to be vertically displaceable on, the housing or frame.

9. The current collector system according to claim 1, wherein there is arranged on the arm and/or the collector trolley at least one part for making physical contact, which, by horizontal movement of the collector trolley, can be brought into physical contact with a positioning means belonging to the line of travel, the collector trolley, when brought into physical contact with the positioning means, being positioned in the horizontal direction for insertion in the at least one conductor bar.

10. The current collector system according to claim 1, wherein the collector trolley or a mounting thereof is resiliently mounted on the arm in the horizontal direction.

11. The current collector system according to claim 1, wherein the at least one current collector is connected to the electronics of the vehicle by means of flexible cables which are fastened to or suspended from the arm at at least one point.

12. The current collector system according to claim 1, wherein travel rollers of the collector trolley have a concave running surface.

13. The current collector system according to claim 1, wherein the collector trolley has at least two vertical guides, of circular cross-section, which are arranged parallel to and at a distance from one another and against which at least two travel rollers, which are rotatably arranged on the head of the arm, rest by their running surfaces.

14. A vehicle having a current collector system according to claim 1, wherein the vehicle has a drive by means of which it can be moved independently of the line of travel, the drive being an electric drive which is fed from a means of storing energy situated in or on the vehicle, or being a drive which is driven by a fuel, the vehicle being able to be driven by means of an electric motor when the vehicle is in contact with the conductor bar by means of the collector trolley.

15. The vehicle according to claim 14, wherein the vehicle has a hybrid drive.

16. A line of travel having at least one conductor bar for transmitting electrical energy and/or data which is arranged along a path of travel for use with at least one vehicle according to claim 14, at least one conductor bar and at least one supporting rail for a collector trolley being arranged along the line of travel, and at least one current collector of the collector trolley being able to make contact with an associated conductor bar, wherein the line of travel has at least one positioning and inserting arrangement for the collector trolley.

17. The line of travel according to claim 16, wherein the positioning and inserting arrangement has a positioning means in the form of a plate for physical contact, for positioning the collector trolley horizontally relative to the conductor bar.

18. The line of travel according to claim 16, wherein the positioning and inserting arrangement has at least one inserting supporting rail which extends upwards at an inclination in the direction of the at least one supporting rail and on which the collector trolley can be moved.

19. The line of travel according to claim 16, wherein two inserting supporting rails which are used to raise the collector trolley are arranged parallel to one another.

20. The line of travel according to claim 16, wherein a running surface of an inserting supporting rail adjoins a running surface of a supporting rail at its upper end, without any offset.

21. The line of travel according to claim 16, wherein a running surface of an inserting supporting rail is formed by a collar of a plate which is formed to be triangular.

22. The line of travel according to claim 16, wherein at least two inserting supporting rails which are arranged parallel to one another form a guiding funnel for the collector trolley.

23. The line of travel according to claim 16, wherein the line of travel has, on one or both sides, two supporting rails which are at a distance from one another in parallel, and which are arranged one above the other, and which serve as travel and guiding rails for the current collector trolley, the supporting rails being formed by tubes.

24. A current and/or data transmission system using a line of travel according to claim 16, and a vehicle able to be moved along the line of travel according to claim 16, the vehicle having a first drive by means of which it can be moved independently of the line of travel, in which case the first drive may be an electric drive which is fed from a means of storing energy situated on the vehicle or is a fuel driven drive, the vehicle being able to be driven by means of an electric motor, which may also be the first drive, when the vehicle is in contact with the conductor bar by means of the collector trolley.

25. The current and/or data transmission system according to claim 24, wherein the vehicle has a hybrid drive.

26. The current and/or data transmission system according to claim 24, wherein the vehicle has an arm which can be moved and/or extended in the horizontal direction to make an electrical connection, and wherein the collector trolley is mounted on the arm to be displaceable in the vertical direction.

27. The current and/or data transmission system according to claim 24, wherein the at least one current collector of the collector trolley can be inserted into a conductor bar on the line of travel by means of a positioning and inserting arrangement in the form of a guiding vee or funnel.
